(19) United States
(12) Patent Application Publication
(10) Pub. No.: US 2025/0244189 A1
(43) Pub. Date: Jul. 31, 2025

(54) SEMICONDUCTOR PACKAGE

(71) Applicant: FUJI ELECTRIC CO., LTD., Kawasaki-shi (JP)

(72) Inventor: Hirofumi KATO, Matsumoto-city (JP)

(73) Assignee: FUJI ELECTRIC CO., LTD., Kawasaki-shi (JP)

(21) Appl. No.: 18/959,044

(22) Filed: Nov. 25, 2024

(30) Foreign Application Priority Data
Jan. 30, 2024 (JP) 2024-011814

(51) Int. Cl. G01L 19/14; G01L 23/10

(52) U.S. Cl. CPC G01L 19/148; G01L 19/147; G01L 23/10

(57) ABSTRACT

A semiconductor package for detecting a pressure of a gas flowing in engine piping, includes a pressure sensor chip configured to convert a pressure of a first pressure medium, which is the pressure of the gas, into an electrical signal, a pressure detection chamber housing the pressure sensor chip such that the pressure sensor chip detects the pressure of the first pressure medium sent thereto, and a pressure intake part disposed between the engine piping and the pressure detection chamber. The pressure intake part has a switch configured to switch between an open state and a closed state by physically receiving an external force. The switch spatially couples the engine piping and the pressure detection chamber via the pressure intake part in the open state, and spatially isolates the engine piping and the pressure detection chamber from each other in the closed state.

### CROSS REFERENCE TO RELATED APPLICATIONS

This application is based upon and claims the benefit of priority of the prior Japanese Patent Application No. 2024-011814, filed on Jan. 30, 2024, the entire contents of which are incorporated herein by reference.

### BACKGROUND OF THE INVENTION

### 1. Field of the Invention

Embodiments of the disclosure relate to a semiconductor package.

### 2. Description of the Related Art

Patent literature for Japanese Utility Model Registration No. 2520601 describes a technology that has a pressure switching valve that is controlled to open and close an intake pressure channel between a pressure sensor and an intake system of an internal combustion engine; the intake pressure channel is closed by the pressure switching valve during deceleration operation of the internal combustion engine; and the technology uses intake pressure (negative pressure) generated by introducing air into the intake pressure channel to clean out fuel, moisture, etc., in the intake pressure channel. Japanese Laid-Open Patent Publication No. 2001-124652 describes a technology that has an on-off valve that moves according to negative pressure in an intake system to open and close a channel between a pressure detection chamber and the outside (atmosphere), and when an accelerator is ON, the valve is in nearly an open state, preventing an intrusion of dirt into the pressure detection chamber by the flow of fresh air introduced from the outside into the pressure detection chamber.

### SUMMARY OF THE INVENTION

According to an embodiment of the present disclosure, a semiconductor package for detecting a pressure of a gas flowing in engine piping includes: a pressure sensor chip configured to convert a pressure of a first pressure medium into an electrical signal, the pressure of the first pressure medium being the pressure of the gas to be detected; a pressure detection chamber housing the pressure sensor chip such that the pressure sensor chip detects the pressure of the first pressure medium sent thereto; and a pressure intake part disposed between the engine piping and the pressure detection chamber, the gas flowing into the pressure intake part from the engine piping as the first pressure medium. The pressure intake part has a switch configured to switch between an open state and a closed state by physically receiving an external force. The switch: in the open state, spatially couples the engine piping and the pressure detection chamber via the pressure intake part, and in the closed state, spatially isolates the engine piping and the pressure detection chamber from each other.

Objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross-sectional view schematically depicting a structure of a semiconductor package according to an embodiment.

FIG. 2 is a cross-sectional view schematically depicting an example of a structure of a pressure sensor in FIG. 1.

FIG. 3 is an enlarged view of a structure of a switch 13 in FIG. 1.

FIG. 4 is a perspective view schematically depicting a structure of a sliding unit in FIG. 3.

FIG. 5 is a perspective view schematically depicting the structure of the sliding unit in FIG. 3.

FIG. 6 is a cross-sectional view schematically depicting a state during transition from an off state to a completely on state of the switch in FIG. 1.

FIG. 7 is a cross-sectional view schematically depicting a state during transition from the off state to the completely on state of the switch in FIG. 1.

FIG. 8 is a cross-sectional view schematically depicting a state during transition from the off state to the completely on state of the switch in FIG. 1.

FIG. 9 is a cross-sectional view schematically depicting the completely on state of the switch in FIG. 1.

FIG. 10 is a cross-sectional view schematically depicting a structure of a semiconductor package of a reference example.

### DETAILED DESCRIPTION OF THE INVENTION

First, problems associated with the conventional technologies are discussed. When an aim is to measure intake pressure like in the patent literature for Japanese Utility Model Registration No. 2520601 and Japanese Laid-Open Patent Publication No. 2001-124652, the pressure medium is nearly equivalent to the outside air (atmosphere) and thus, even when a semiconductor package for measuring pressure (pressure sensor circuit and components thereof) will be exposed to a pressure medium for long periods, deterioration of the semiconductor package due to the pressure medium needs not be considered. However, when an aim is to measure exhaust pressure, because engine piping is sealed at all times, the inside of the semiconductor package is exposed to the pressure medium for long periods and the pressure medium contains corrosive substances. Thus, in this instance, deterioration of a semiconductor package for measuring pressure is a significant concern.

Here, an outline of an embodiment of the present disclosure is described. (1) A semiconductor package according to one aspect of the present disclosure is a semiconductor package that detects the pressure of a gas that flows through engine piping; the semiconductor package includes a pressure sensor chip, a pressure detection chamber, and a pressure intake part. The pressure sensor chip converts pressure received from a first pressure medium into an electrical signal. The pressure detection chamber houses the pressure sensor chip. The first pressure medium is sent to the pressure detection chamber. The pressure intake part is provided between the engine piping and the pressure detection chamber. The gas, as the first pressure medium, flows into the pressure intake part from the engine piping. The pressure intake part has a switch that receives a physical, external force, moves, opens, and closes. The switch, when in an open state, spatially couples the engine piping and the pressure detection chamber via the pressure intake part, and when in a closed state, spatially isolates the engine piping and the pressure detection chamber from each other.

According to the disclosure above, during the closed state of the switch, the inside of the pressure detection chamber may be shielded from the high-temperature, high-humidity gas in the engine pipe and thus, deterioration of the pressure sensor chips and the components thereof due to rust, corrosion, hygroscopic expansion, etc. may be suppressed.
(2) Further, in the semiconductor package according to the present disclosure, in (1) above, the switch may receive pressure from a second pressure medium, which is a branched portion of the first pressure medium, the semiconductor package may move in a first direction, and enter the open state.

According to the disclosure above, the open state of the switch may be physically realized easily.
(3) Further, in the semiconductor package according to the present disclosure, in (1) or (2) above, the switch may have a first holding unit that suppresses movement of the switch in the first direction and when the second pressure medium disappears, the switch may be pushed back by the first holding unit in a second direction that is opposite to the second direction and may enter a closed state.

According to the disclosure above, when the engine is stopped, the closed state of the switch may be maintained.
(4) Further, in the semiconductor package according to the present disclosure, in (3) above, the first holding unit is a compression coil spring that generates a pushing force that pushes the switch back in the second direction. The switch may continuously receive the pushing force from the first holding unit.

According to the disclosure above, when the engine stops, the switch may concurrently transition from the open state to the closed state.
(5) Further, in the semiconductor package according to the present disclosure, in (4) above, the switch may be kept in the closed state by the pushing force from the first holding unit.

According to the disclosure above, the switch may be kept physically in the closed state easily.
(6) Further, in the semiconductor package according to the present disclosure, in (2) above, the switch has a second holding unit that pulls and holds the switch in the first direction. The switch may be held and kept in the open state by the second holding unit when the switch moves in the first direction and is in the open state or when the switch moves in the first direction and approaches the open state.

According to the disclosure above, during the open state of the switch, the switch may be prevented from being pushed and returning in the second direction by the first holding unit.
(7) Further, in the semiconductor package according to the present disclosure, in (6) above, the second holding unit may have an electromagnet that generates an attractive force that pulls the switch in the first direction.

According to the disclosure above, the open state of the switch may be physically realized easily.
(8) Further, in the semiconductor package according to the present disclosure, in (7) above, the second holding unit may pull and hold the switch by the generated attractive force, when the switch has moved in the first direction and approaches the electromagnet within a predetermined distance.

According to the disclosure above, the switch may be prevented from being in the open state continuously.
(9) Further, in the semiconductor package according to the present disclosure, in (7) above, the electromagnet has a coil and power may be supplied to the coil by a power source that supplies power to the pressure sensor chip.

According to the disclosure above, power may be easily supplied to the coil of the electromagnet.
(10) Further, in the semiconductor package according to the present disclosure, in any one of (1) to (9) above, the switch has an atmospheric opening and during the closed state, the pressure detection chamber and the outside may be spatially coupled via the atmospheric opening.

According to the disclosure above, during the closed state of the switch, the inside of the pressure detection chamber may be open to the atmosphere and exposed to the atmosphere (the outside air) and thus, deterioration of the pressure sensor chip and the components thereof may be significantly reduced.

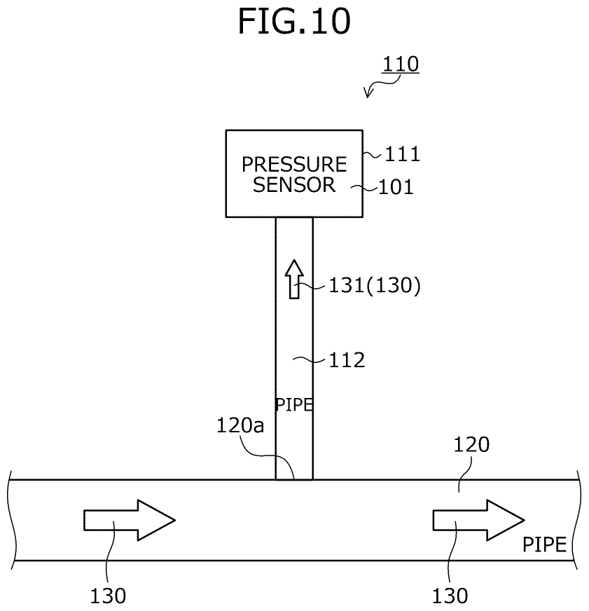

Findings underlying the present disclosure are discussed. First, as a semiconductor package of a reference example, a structure of an on-board automotive sensor package for exhaust pressure measurement of an internal combustion engine (the engine) is described. FIG. 10 is a cross-sectional view schematically depicting a structure of a semiconductor package of a reference example. A semiconductor package 110 of the reference example depicted in FIG. 10 includes a pressure sensor 111 and a pressure intake part 112 and is an on-board automotive sensor package installed to a pipe (an exhaust pipe 120) of an exhaust system of an engine. The pressure sensor 111 is equipped with a pressure sensor chip (not depicted) mounted in a space (hereinafter, the pressure detection chamber) inside a case 101.

The case 101 is a resin molded product in which a lead frame (not depicted) is insert molded. A bonding wire (not depicted) electrically connects the pressure sensor chip to the lead frame insert molded in the case 101. The pressure sensor chip is a semiconductor integrated circuit (IC) employing a piezoresistive method that utilizes the piezoresistive effect of a diffused resistor formed in a silicon (Si) semiconductor, the semiconductor IC having a gauge surface (circuit surface where a strain gauge is provided) that is a pressure-sensitive surface sensitive to a pressure medium 131.

The pressure intake part 112 is a channel for the pressure medium 131 that is sent to the pressure detection chamber. The pressure intake part 112 is a resin pipe (piping made of resin) integrally molded with the case 101 and a first open end of the pressure intake part 112 is connected to the pressure detection chamber. A second open end of the pressure intake part 112 is inserted into an opening (hereinafter, mounting hole) 120a formed in the exhaust pipe 120 of the engine, whereby the semiconductor package 110 is directly attached to the exhaust pipe 120. The pressure detection chamber (space) and the inside of (space in) the exhaust pipe 120 are coupled by the pressure intake part 112 thereby creating a space that is continuous at all times.

An O-ring (not depicted) provided along an outer periphery of the pressure intake part 112 seals a gap at a joint between the pressure intake part 112 and the exhaust pipe 120 to thereby maintain airtightness. A length of the pressure intake part 112 is short and the pressure sensor 111 is disposed at a position relatively close to the exhaust pipe 120. The exhaust pipe 120 is a hollow, cylindrical resin pipe through which exhaust gas 130 flows during exhaust strokes of the engine and connects cylinders of the engine (not depicted) and the outside (atmosphere). A portion of the exhaust gas 130 is sent, as the pressure medium 131, to the pressure detection chamber through the pressure intake part 112.

Operation of the semiconductor package 110 of the reference example is described. When the engine is running, during a process of exhausting combustion gas that is generated in the cylinders of the engine during a combustion/expansion process of the internal combustion engine, the exhaust gas 130 is exhausted outside of the automotive vehicle, through the exhaust pipe 120. At this time, the exhaust gas 130 flows into the pressure intake part 112 from the exhaust pipe 120 and is sent to the pressure detection chamber of the pressure sensor 111, as the pressure medium 131. The diaphragm is distorted by pressure exerted by the pressure medium 131 and the pressure sensor 111 outputs an electrical signal corresponding to the distortion of a diaphragm of the pressure sensor chip.

The O-ring increases the airtightness between the pressure intake part 112 and the exhaust pipe 120 and thus, the pressure medium 131 that flows into the pressure intake part 112 from the exhaust pipe 120 is sent the pressure sensor chip without leaking externally. Normally, the exhaust pipe 120 is not equipped with an atmospheric release valve for introducing atmospheric air and thus, is sealed at all times and is not open to the atmosphere. When the engine is stopped, air (oxygen) intake to the engine stops and thus, the exhaust gas 130 remains in the exhaust pipe 120 and the inside of the exhaust pipe 120 is exposed to the exhaust gas 130, which has a high temperature and high humidity.

The airtightness between the pressure intake part 112 and the exhaust pipe 120 is high and thus, the exhaust gas 130 inside the exhaust pipe 120 and inside the semiconductor package 110 (inside the pressure intake part 112 and inside the pressure detection chamber) is difficult to exhaust outside. A path of the pressure medium 131 (the exhaust gas 130) from the exhaust pipe 120 to the pressure detection chamber is spatially continuous at all times and no member for shielding the pressure sensor chip from the exhaust gas 130 is equipped. Even after the engine has stopped, the pressure sensor chip is not exposed to the outside air and continues to be exposed to the exhaust gas 130 that remains inside the exhaust pipe 120.

The exhaust gas 130 contains corrosive substances of environmental concern such as sulfur oxides (SOx) and nitrogen oxides (NOx), as well as water vapor generated during the combustion of fuel (such as gasoline). Thus, when the inside of the semiconductor package 110 is exposed to the pressure medium 131 (particularly, the humidity), there is significant concern that the pressure sensor chip and the components thereof may deteriorate due to rust, corrosion, hygroscopic expansion, and other factors. As described, the airtightness between the pressure intake part 112 and the exhaust pipe 120 is high and thus, for long periods, the inside of the semiconductor package 110 is exposed to the pressure medium 131, which has a high temperature and high humidity.

In the present embodiment, suppressing deterioration of a pressure sensor chip and components thereof (bonding wire, etc.) is one problem to be solved.

Embodiments of a semiconductor package according to the present disclosure are described in detail with reference to the accompanying drawings. In the description of the embodiments and the accompanying drawings herein, components that are the same are given the same reference characters and are not repeatedly described.

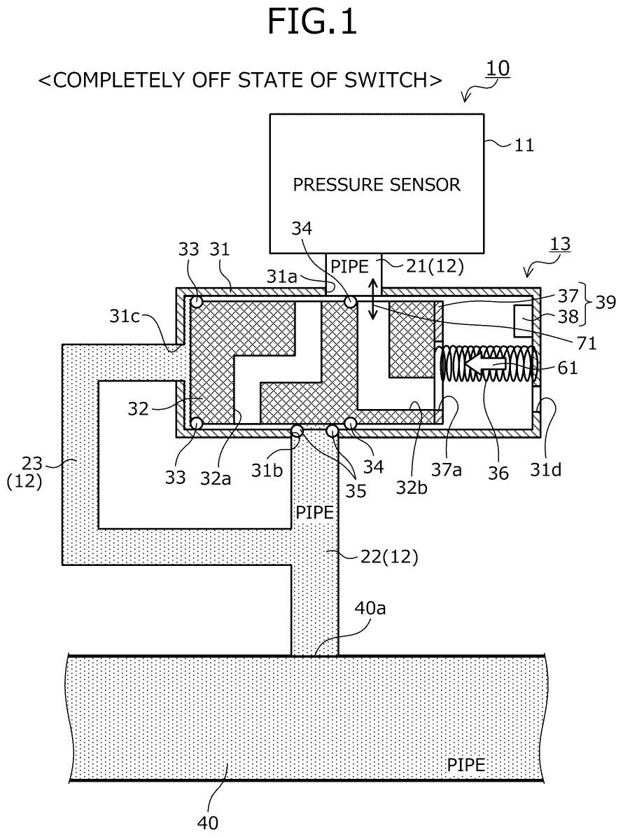

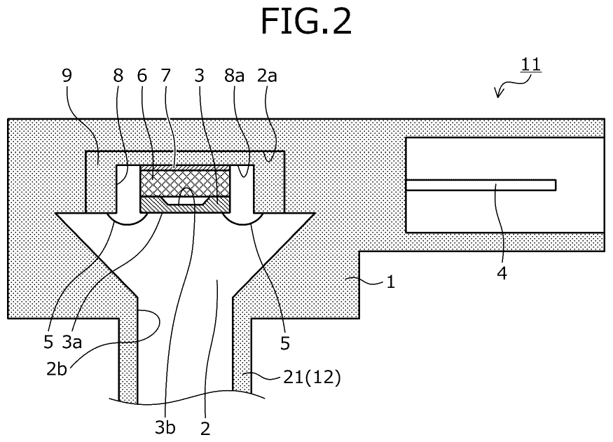

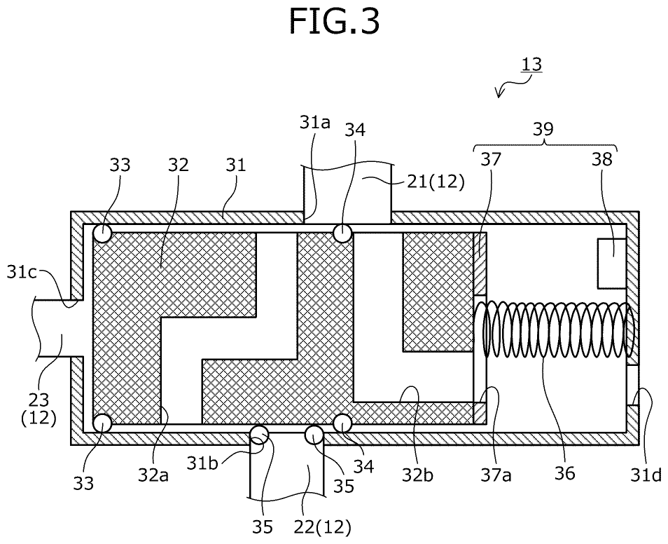

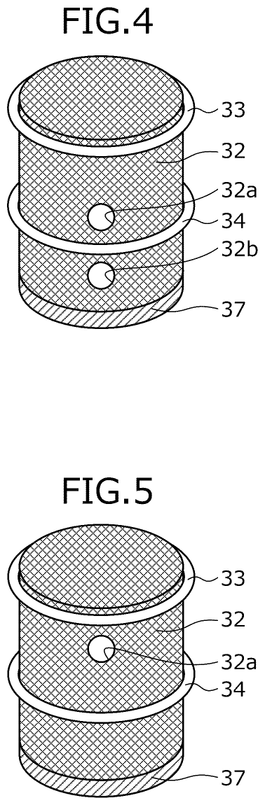

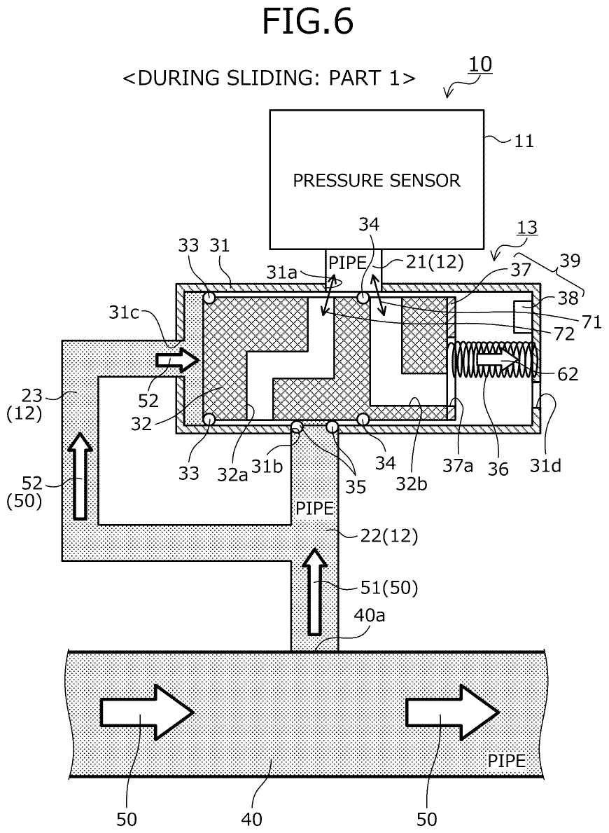

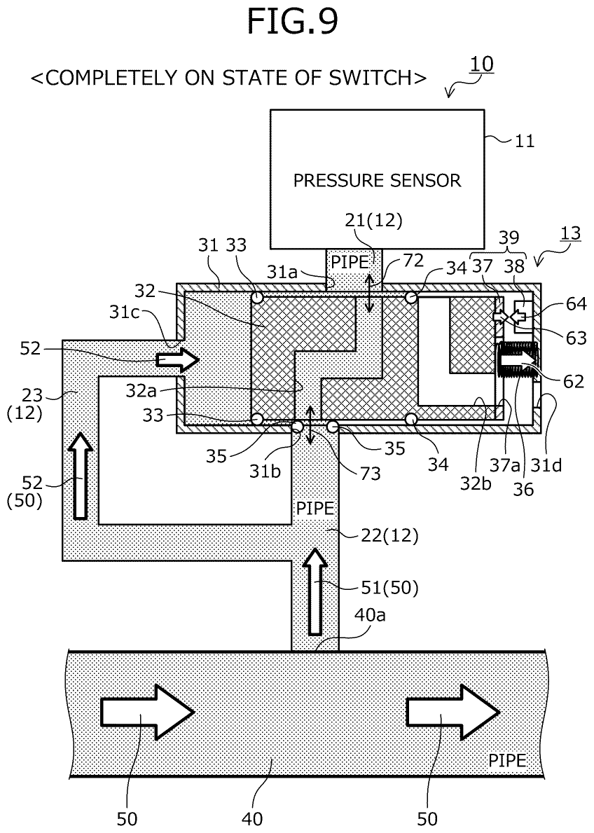

A semiconductor package according to an embodiment solving the problems discussed above is described. FIG. 1 is a cross-sectional view schematically depicting a structure of the semiconductor package according to the embodiment. FIG. 1 depicts a state in which a switch 13 is completely off. FIG. 2 is a cross-sectional view schematically depicting an example of a structure of a pressure sensor in FIG. 1. FIG. 3 is an enlarged view of a structure of the switch 13 in FIG. 1. FIGS. 4 and 5 are perspective views schematically depicting a structure of a sliding unit in FIG. 3. FIGS. 4 and 5 depict, respectively, states when a sliding unit 32 is viewed from an upper curved surface and a lower curved surface. FIGS. 6, 7, and 8 are cross-sectional views schematically depicting states during transition from an off state to a completely on state of the switch in FIG. 1. FIG. 9 is a cross-sectional view schematically depicting the completely on state of the switch in FIG. 1.

A semiconductor package 10 according to the embodiment depicted in FIGS. 1 to 5, and 9 includes a pressure sensor 11 and a pressure intake part 12 and is an automotive sensor package that is for measuring pressure and installed to piping of an internal combustion engine (engine). Herein, while an instance is described in which the semiconductor package 10 is installed to a pipe (an exhaust pipe 40) of an exhaust system of the engine to measure exhaust pressure, the semiconductor package 10 may be installed to other piping in an automotive vehicle. The semiconductor package 10 is useful when it is desirable to expose the pressure sensor 11 to the outside air (atmosphere) during standby (when pressure is not being measured) in a pressure measurement application in which a pressure medium is gas flowing in a pipe that does not have an atmosphere release valve, and the semiconductor package is particularly suitable for pressure measurement (exhaust pressure measurement) of a pressure medium that is exhaust gas 50 containing corrosive substances.

The semiconductor package 10 is a component of the exhaust system of the engine and is installed to the exhaust pipe 40. In the pressure sensor 11, a pressure sensor chip (semiconductor substrate) 3 is mounted in a space (pressure detection chamber) 2 inside a case 1 (refer to FIG. 2), the pressure sensor chip 3 outputs an electrical signal corresponding to a received (sensed) pressure, the electrical signal being output via a lead frame 4 to an external circuit. The pressure sensor 11 is supplied with voltage from a power source IC (not depicted) of an engine control unit (ECU) for controlling the engine or a power source IC (not depicted) of an electronic control unit (ECU) for controlling the driving performance, safety, and environmental friendliness of the automotive vehicle and is controlled by the ECU.

The case 1 is a resin molded product in which the lead frame 4 is insert molded. The case 1, a later-described housing container body 9, the pressure intake part 12 (later-described first to third pipes 21 to 23), a later-described support housing 31, the later-described sliding unit 32, and the exhaust pipe 40, for example, are formed of a high-performance resin having excellent heat resistance, mechanical strength, durability (chemical resistance, abrasion resistance), non-combustibility, electrical insulation, processability, etc., a so-called super engineering plastic such as polyphenylene sulfide (PPS). Thus, as compared to an instance in which these components of the exhaust system of the engine are formed of a metal, the suppression of corrosion due to the exhaust gas 50 and a reduction in the weight of the exhaust system of the engine may be realized.

The pressure detection chamber 2 is a space having a substantially rectangular shape (in FIG. 2, an inverted trapezoidal shape) bordered by an inner wall of the case 1. The inside of the pressure detection chamber 2 is exposed to the exhaust gas 50, which is sent as a pressure medium 51 from the exhaust pipe 40 via the pressure intake part 12 when the later-described switch 13 is on (in an open state). When the switch 13 is off (closed state), the inside of the pressure detection chamber 2 is spatially isolated from the exhaust pipe 40 and is open to the atmosphere and exposed to the outside air. At a ceiling (a first portion of an inner wall of the case 1, opposite a second portion of the inner wall facing the exhaust pipe 40) of the pressure detection chamber 2, a recess 2a where the pressure sensor chip 3 is mounted is provided. At a floor (the second portion of the inner wall of the case 1, facing the exhaust pipe 40) of the pressure detection chamber 2, a pressure inlet 2b to the pressure detection chamber 2 is provided. The pressure detection chamber 2 and the first pipe 21 are coupled (connected) by the pressure inlet 2b thereby creating a space that is continuous at all times.

The pressure sensor chip 3 is a semiconductor IC employing a piezoresistive method that utilizes the piezoresistive effect of a diffused resistor (gauge resistor) formed in a silicon (Si) semiconductor, the semiconductor IC having a gauge surface (circuit surface where a strain gauge is provided) that is a pressure-sensitive surface sensitive to the pressure medium 51. The pressure sensor chip 3 has a center portion and an external peripheral portion and a diaphragm structure in which the center portion is etched from a back surface of the pressure sensor chip 3 thereby forming a recess 3b whereby a thickness of the pressure sensor chip 3 is thinner at the center portion than at the external peripheral portion. The pressure sensor chip 3 includes a diaphragm (pressure sensitive portion) 3a that bends due to pressure, a strain gauge (not depicted), and computing circuitry (not depicted) for amplifying and compensating output of the strain gauge. The diaphragm 3a has, for example, a circular shape in a plan view.

The strain gauge contains a material (Si semiconductor) having a piezoresistive effect and is configured by multiple gauge resistors (not depicted) connected to a bridge, the gauge resistors each having substantially a same shape and substantially a same resistance value, and the strain gauge being provided on a front side of the pressure sensor chip 3 facing the diaphragm 3a. The gauge resistors are each electrically connected to the lead frame 4 via bonding wires 5 and a surface electrode (not depicted) on a front surface of the pressure sensor chip 3. Distortion of the diaphragm 3a occurring when pressure from the pressure medium 51 is received is converted by the strain gauge into an electrical signal of a magnitude proportional to the pressure (potential difference occurring among the bridge of the gauge resistors in proportion to the pressure), and the electrical signal is led out to the external circuit via the lead frame 4. A main material of the lead frame 4, for example, is phosphor bronze.

The external peripheral portion of the back surface of the pressure sensor chip 3, for example, is electrostatically bonded (anode bonded) to a first surface of a pedestal member 6 so that the recess 3b at the back surface of the pressure sensor chip 3 is sealed by the pedestal member 6. A second surface of the pedestal member 6 is die-bonded (fixed) to a floor 8a of a sensor mounting portion 8 via an adhesive 7. The pressure sensor chip 3 and the pedestal member 6 are disposed apart from sidewalls of the sensor mounting portion 8. The pedestal member 6, for example, is a glass substrate formed of heat-resistant glass. The sensor mounting portion 8 is a recess that houses the pressure sensor chip 3 and is formed inside the housing container body 9. Inside the sensor mounting portion 8, the pressure sensor chip 3 and the bonding wires 5 may be encapsulated by a general encapsulant. Provided the housing container body 9 is of a size that fits inside the recess 2a of the pressure detection chamber 2, the shapes of the housing container body 9 and the recess 2a of the pressure detection chamber 2 in a plan view may be variously modified.

The pressure intake part 12 has the first to third pipes 21 to 23 and the switch 13. The first to third pipes 21 to 23 are hollow, cylindrical resin pipes with diameters that are smaller than the diameter of the exhaust pipe 40. The first pipe 21 is integrally molded with the case 1 and has a first open end connected to the pressure inlet 2b of the pressure detection chamber 2. The first pipe 21 protrudes from a lower surface (surface facing the switch 13) of the case 1, is disposed between the case 1 and the switch 13, and has a second open end that is inserted in a hole (hereinafter, mounting hole) 31a formed in the support housing 31 of the switch 13, at an upper curved surface (a portion of a side surface of the support housing 31, facing the pressure sensor 11) of the support housing 31. The first pipe 21 may be integrally molded with the support housing 31. The first pipe 21 constitutes a channel of the pressure medium 51 that is sent to the pressure detection chamber 2 when the switch 13 is on and constitutes an intake path for the outside air to the pressure detection chamber, the first pipe 21 being open to the atmosphere when the switch 13 is off. A length of the first pipe 21 is short and the pressure sensor 11 and the switch 13 are positioned relatively close to each other.

The second pipe 22 is disposed between the switch 13 and the exhaust pipe 40. A first open end of the second pipe 22 is inserted in a mounting hole 31b formed in the support housing 31 of the switch 13, at a lower curved surface (a portion of the side surface of the support housing 31, facing the exhaust pipe 40) of the support housing 31. The second pipe 22 may be integrally formed with the support housing 31. A second open end of the second pipe 22 is inserted in a mounting hole 40a formed in a curved surface (side surface) of the exhaust pipe 40 and thus, the semiconductor package 10 is installed (attached) directly to the exhaust pipe 40. When the engine is running (when the automotive vehicle is traveling, idling, etc.), the exhaust gas 50 flowing in the exhaust pipe 40 flows into the second pipe 22 as the pressure medium (first pressure medium) 51. The second pipe 22 is a channel for the pressure medium 51 that is to be sent to the pressure detection chamber 2. The second pipe 22 is spatially continuous with the exhaust pipe 40 at all times. The inside of the second pipe 22 is not directly exposed to the outside air. A length of the second pipe 22 is short, and the pressure sensor 11 is disposed at a position relatively close to the exhaust pipe 40.

The third pipe 23 is disposed between the switch 13 and the exhaust pipe 40. A first open end of the third pipe 23 is inserted into a pressure inlet 31c formed in a first bottom (first end) of the support housing 31 of the switch 13. The third pipe 23 may be integrally molded with the support housing 31. A second open end of the third pipe 23 is inserted into a mounting hole formed in a side surface of the second pipe 22. The third pipe 23 may be integrally molded with the second pipe 22. The third pipe 23 constitutes a channel for a pressure medium (second pressure medium) 52 that manipulates the sliding unit 32. The third pipe 23 is spatially continuous with the exhaust pipe 40 via the second pipe 22 at all times and the inside of the third pipe 23 is not directly exposed to the outside air. The third pipe 23 is a path branch for directing a portion of the exhaust gas 50 (the pressure medium 51) that flows from the exhaust pipe 40 into the second pipe 22, the third pipe 23 directing said portion of the exhaust gas 23 to the switch 13 as the pressure medium 52.

The switch 13 has a function of coupling the pressure detection chamber 2 and the exhaust pipe 40 by turning on when the engine is running to thereby connect the channel (a first through-hole 32a of the later-described sliding unit 32) for the pressure medium 51 between the first and second pipes 21, 22. The switch 13 is kept completely on by a later-described second holding unit 39 while the engine is running, thereby shielding the pressure detection chamber 2 from the atmosphere and continuing to couple the pressure detection chamber 2 to the exhaust pipe 40. On the other hand, the switch 13 has a function of opening the pressure detection chamber 2 to the atmosphere by turning off when the engine is stopped (not running), thereby interrupting the space between the first and second pipes 21, 22, shielding the pressure detection chamber 2 from the pressure medium 51, and connecting an atmosphere path (a second through-hole 32b of the later-described sliding unit 32) to the pressure detection chamber 2. The switch 13 continuously maintains the completely off state by a later-described first holding unit 36 while the engine is stopped, shields the pressure detection chamber 2 from the pressure medium 51, and keeps the pressure detection chamber 2 open to the atmosphere.

In particular, the switch 13 has the support housing 31, the sliding unit 32, sealing members 33, 34, 35, and the first and second holding units 36, 39 (FIG. 3). The support housing 31 has a hollow cylindrical shape and houses the sliding unit 32 therein. The support housing 31 is disposed between the pressure sensor 11 (the case 1) and the exhaust pipe 40, with a curved surface (side surface) thereof facing the lower surface of the case 1 and a curved surface of the exhaust pipe 40. In the support housing 31, at the upper curved surface and the lower curved surface thereof, the mounting holes 31a, 31b that penetrate through the support housing 31 from an outer wall thereof to an inner wall thereof are formed, respectively. The support housing 31 is connected to the first pipe 21 by the mounting hole 31a at the upper curved surface of the support housing 31 and forms a space that is continuous with the pressure detection chamber 2 at all times via the first pipe 21. The support housing 31 is connected to the second pipe 22 by the mounting hole 31b at the lower curved surface the support housing 31 and forms a space that is continuous with the exhaust pipe 40 at all times via the second pipe 22.

At bottoms (ends) of the support housing 31, the pressure inlet 31c and an atmospheric opening 31d are formed, respectively, penetrating through the support housing 31, from the outer wall of the support housing 31 to the inner wall of the support housing 31. The support housing 31 is connected to the third pipe 23 by the pressure inlet 31c and forms a space that is continuous with the exhaust pipe 40 at all times via the third and second pipes 23, 22. The support housing 31 forms a space that is continuous with the outside (outside the automotive vehicle) by the atmospheric opening 31d at all times. The space inside the support housing 31 continuous with the exhaust pipe 40 is shielded from the outside air by the sliding unit 32 and the sealing members 33, 34. The support housing 31 supports the sliding unit 32 in a state enabling the sliding unit 32 to be moved (slid) in an axial direction of the support housing 31 (direction orthogonal to the bottom; in FIG. 3, a horizontal direction). The support housing 31 has a function of preventing misalignment of the sliding unit 32 in a radial direction (direction orthogonal to the axial direction; in FIG. 3, a vertical direction) of the support housing 31.

In the mounting holes 31a, 31b of the support housing 31, open ends of the later-described first through-hole 32a of the sliding unit 32 are exposed when the switch 13 is on. The mounting holes 31a, 31b of the support housing 31 may or may not face each other in a radial direction of the support housing 31. The pressure inlet 31c and the atmospheric opening 31d of the support housing 31 may or may not face each other in the axial direction of the support housing 31. Preferably, the pressure inlet 31c, for example, may be formed in a center of the first bottom of the support housing 31. As a result, inside the support housing 31, when the sliding unit 32 is movable in the axial direction of the support housing 31, dispersion of the pressure caused by the pressure medium 52 may be suppressed. Provided that the atmospheric opening 31d of the support housing 31 forms a continuous space with the later-described second through-hole 32b of the sliding unit 32 at all times, arrangement of the atmospheric opening 31d may be suitably set.

The sliding unit 32 is a round cylindrical resin member having a diameter that is slightly smaller than an inner diameter (diameter of cavity of the support housing 31) of the support housing 31 and a height (length) that is lower (less) than a height (length) of the support housing 31. The sliding unit 32 is housed inside the support housing 31 so that an axial direction (direction orthogonal to the bottom (end)) of the sliding unit 32 and the axial direction of the support housing 31 coincide with each other. A gap between the curved surface of the sliding unit 32 and the curved inner wall of the support housing 31 is partially sealed by the sealing members 33, 34. The sliding unit 32 is supported by the curved inner wall of the support housing 31 via the sealing members 33, 34. The sliding unit 32 suffices to be supported by the curved inner wall of the support housing 31 in a state enabling the sliding unit 32 to move axially within the support housing 31 when an external physical force in the axial direction (a pushing force from the later-described first holding unit 36 and a compressive load 62 on the first holding unit 36 from the pressure medium 52) is applied to the sliding unit 32.

The first and second through-holes 32a, 32b are formed in the sliding unit 32. The first and second through-holes 32a, 32b have a substantially circular shape in a plan view. The first through-hole 32a penetrates through the sliding unit 32, from an upper curved surface (a portion of a curved surface of the sliding unit 32, facing the first pipe 21) of the sliding unit 32 to a lower curved surface (a portion of the curved surface of the sliding unit 32, facing the second pipe 22) of the sliding unit 32 (refer to FIGS. 3 to 5). The first through-hole 32a is moved to be between the first and second pipes 21, 22 when the switch 13 is on, thereby, coupling the first pipe 21 and the second pipe 22 (refer to FIG. 9). Thus, the first through-hole 32a constitutes the channel for the pressure medium 51 that is sent to the pressure detection chamber 2 when the switch 13 is on. Preferably, a diameter of the first through-hole 32a is as large as possible, but not larger than diameters of the first and second pipes 21, 22. Variation of the pressure in the channel for the pressure medium 51 when the switch 13 is on may be reduced by increasing the diameter of the first through-hole 32a.

The diameter of the first through-hole 32a is smaller than the diameters of the first and second pipes 21, 22 which ensures that, when the switch 13 is in the completely on state, the open ends of the first through-hole 32a entirely face the respective ends of the first and second pipes 21, 22, facing the sliding unit 32. Thus, airtightness between the first through-hole 32a and the first and second pipes 21, 22 when the switch 13 is in the completely on state is increased, whereby flow (pressure leakage) of the pressure medium 51 into the gap between the curved surface of the sliding unit 32 and the curved inner wall of the support housing 31 may be prevented. During movement of the sliding unit 32 of the switch 13 (while sliding in the axial direction), a period may occur in which both the first and second through-holes 32a, 32b are coupled to the first pipe 21 (refer to FIG. 6). During the period when the first and second through-holes 32a, 32b are both coupled to the first pipe 21, preferably, the first through-hole 32a is separated from the second pipe 22.

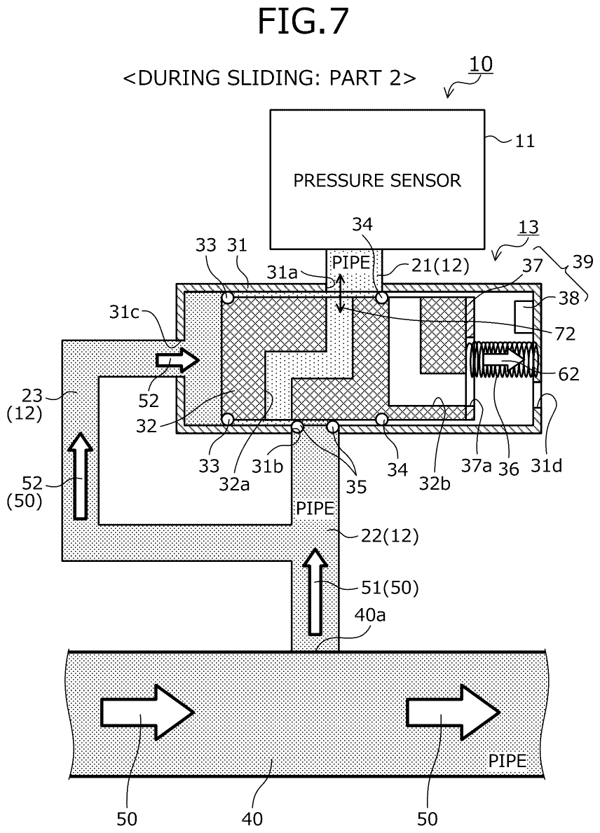

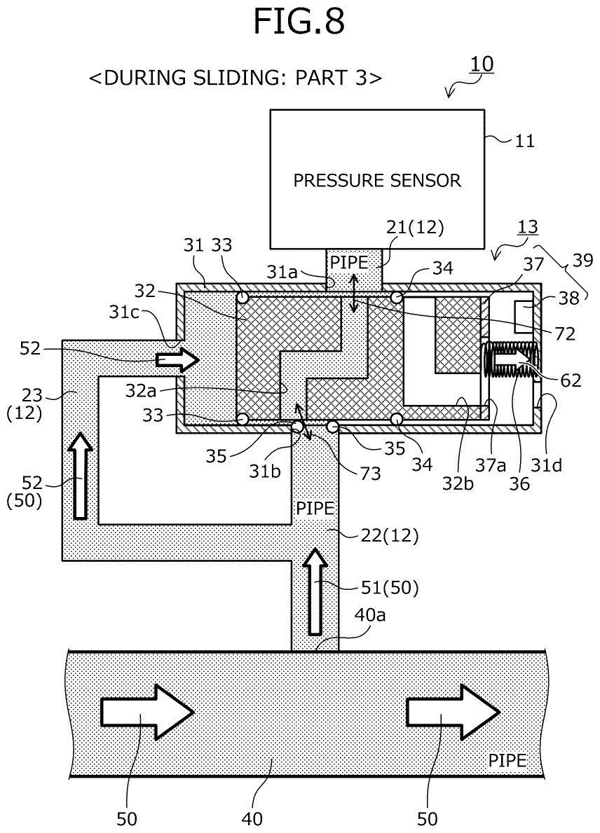

For example, the first through-hole 32a has a cross-sectional shape that is bent in a substantially L-shape at portion so that the open end thereof at the lower curved surface of the sliding unit 32 is positioned closer to the pressure-sensitive surface sensitive to the pressure medium 52 (first bottom surface of the sliding unit 32, facing the pressure inlet 31c) than is the open end thereof at the upper curved surface of the sliding unit 32. As a result, during the period when the first and second through-holes 32a, 32b are both coupled to the first pipe 21, the first through-hole 32a may by coupled to only the first pipe 21 and the first through-hole 32a may be separated from the second pipe 22. Further, during a period when the first and second pipes 21, 22 are coupled to each other via the first through-hole 32a, the second through-hole 32b and the first pipe 21 may be separated from each other (refer to FIGS. 8 and 9). During movement of the sliding unit 32 of the switch 13, a period may occur when only the first through-hole 32a is coupled to the first pipe 21 and the first through-hole 32a is apart from the second pipe 22 (refer to FIG. 7).

The second through-hole 32b penetrates through the sliding unit 32 at a position closer to the atmospheric opening 31d of the support housing 31 than is the first through-hole 32a (refer to FIGS. 3 and 4). The second through-hole 32b has a first open end at the upper curved surface of the sliding unit 32 and a second open end spatially continuous with the outside at all times via the atmospheric opening 31d of the support housing 31. When the switch 13 is off, the second through-hole 32b is coupled to the first pipe 21 and constitutes the intake path for the outside air to the pressure detection chamber (refer to FIG. 1). When the switch 13 is off, the first pipe 21 and the pressure detection chamber 2 are open to the atmosphere via the second through-hole 32b. The second open end of the second through-hole 32b, for example, preferably, may be positioned at a second bottom surface of the sliding unit 32 facing the atmospheric opening 31d (the second bottom surface being opposite to the first bottom surface that faces the pressure-sensitive surface sensitive to the pressure medium 52) and more preferably, the second open end of the second through-hole 32b may face the atmospheric opening 31d in the axial direction of the sliding unit 32.

Provided that the first open end of the second through-hole 32b is positioned at the upper curved surface of the sliding unit 32 and the second open end is spatially continuous with the outside via the atmospheric opening 31d, the cross-sectional shape of the second through-hole 32b may be suitably set. FIG. 3 depicts an instance in which the second through-hole 32b has a substantially L-shaped cross-sectional shape and penetrates through the sliding unit 32 from the upper curved surface of the sliding unit 32 to the second bottom surface thereof facing the atmospheric opening 31d. Preferably, a diameter of the second through-hole 32b is as small as possible and not more than the diameter of the first pipe 21. The smaller is the diameter of the second through-hole 32b, the shorter is a period until the first pipe 21 and the atmospheric opening 31d are spatially isolated from each other after the engine starts. As a result, when the engine is running, the period when the pressure detection chamber 2 is open to the atmosphere becomes shorter, whereby the accuracy of pressure detection by the pressure sensor 11 may be enhanced.

Preferably, the second through-hole 32b is separated from the first pipe 21 during a period when the pressure medium 51 is sent to the pressure detection chamber 2 (period when the first and second pipes 21, 22 are coupled to each other via the first through-hole 32a) (refer to FIGS. 8 and 9). The second through-hole 32b and the first pipe 21 are separated from each other, whereby the first pipe 21 and the atmospheric opening 31d are spatially isolated from each other. Thus, during the period when the pressure medium 51 is sent to the pressure detection chamber 2, intrusion of the outside air into the pressure detection chamber 2 may be prevented. The second through-hole 32b is positioned in the support housing 31, in a space therein coupled to the outside air and is shielded from a space in the support housing 31 coupled to the exhaust pipe 40, the second through-hole 32b being shielded by the sliding unit 32 and the sealing member 34. A distance between the first and second through-holes 32a, 32b may be suitably set according to respective heights (respective lengths in the axial direction) of the support housing 31 and the sliding unit 32.

The sealing members 33, 34, for example, are general O-rings, are in contact with the curved surface of the sliding unit 32, and surround an outer periphery of the sliding unit 32 (refer to FIGS. 4 and 5). The sealing members 33 and 34 support the curved surface of the sliding unit 32 against the curved inner wall of the support housing 31. The sealing members 33, 34 suffice to protrude from the curved surface of the sliding unit 32, and the sealing members 33, 34 may be fixed by fitting the sealing members 33, 34 into grooves provided at the curved surface of the sliding unit 32. The sealing member 33 is disposed closer to the pressure-sensitive surface sensitive to the pressure medium 52 (the first bottom surface of the sliding unit 32, facing the pressure inlet 31c) than is the first through-hole 32a and, preferably, may surround a periphery of the pressure-sensitive surface sensitive to the pressure medium 52. The sealing member 33 has a function of preventing flow (pressure leakage) of the pressure medium 52 from the pressure-sensitive surface sensitive to the pressure medium 52 into the gap between the curved surface of the sliding unit 32 and the curved inner wall of the support housing 31.

The sealing member 34 is disposed between the first and second through-holes 32a, 32b and preferably, in addition, may be disposed between the second through-hole 32b and the second pipe 22. The sealing member 34 has a function of preventing an inflow of the outside air into the first and second pipes 21, 22 and the first through-hole 32a from the atmospheric opening 31d. Further, preferably, the sealing member 34 may be disposed between the first and second through-holes 32a, 32b, at a position close to the second through-hole 32b. The closer the sealing member 34 is positioned to the second through-hole 32b, the shorter is the period until the first pipe 21 and the atmospheric opening 31d are spatially isolated from each other after the engine starts. As a result, when the engine is running, the period when the pressure detection chamber 2 is open to the atmosphere becomes shorter and thus, the accuracy of the pressure detection by the pressure sensor 11 may be enhanced.

The sealing member 35, for example, is a general O-ring and in the support housing 31, surrounds a periphery of an open end of the second pipe 22. Between the sealing members 33, 34, the sealing member 35 is in contact with the lower curved surface of the sliding unit 32. The sealing member 35 has the function of sealing the gap at a joint between the mounting hole 31b of the support housing 31 and the second pipe 22, thereby maintaining airtightness between the support housing 31 and the second pipe 22. Further, the sealing member 35 has a function of maintaining air tightness between the first through-hole 32a and the second pipe 22 by sealing the gap between the first through-hole 32a and the second pipe 22, when the switch 13 is in the completely on state. When the switch 13 is in the completely on state, the sealing member 35 may prevent flow (pressure leakage) of the pressure medium 51 into the gap between the curved surface of the sliding unit 32 and the curved inner wall of the support housing 31.

The first and second holding units 36, 39 are disposed in the support housing 31, between the second bottom surface of the sliding unit 32 facing the atmospheric opening 31d and a second bottom of the support housing 31 facing the atmospheric opening 31d. The first holding unit 36 has a function of continuously applying a physical external force 61 to the sliding unit 32, the external force 61 pushing the sliding unit 32 back in the axial direction toward the pressure inlet 31c (a second direction). When the switch 13 is off, the first holding unit 36 pushes the sliding unit 32 back to a position closest to the pressure inlet 31c in the support housing 31 and holds the sliding unit 32 in that position. The first holding unit 36 suppresses movement of the sliding unit 32 in a direction to the atmospheric opening 31d (a first direction), and the switch 13 is maintained in the completely off state. The completely off state of the switch 13 is when the engine is stopped and the pressure detection chamber 2 is completely shielded from the pressure medium 51.

More specifically, the first holding unit 36, for example, is configured by a general compression coil spring (push spring), and both ends of the holding unit 36 are fixed (for example, adhered), respectively, to the second bottom surface of the sliding unit 32 (or a later-described conductive plate 37) and a portion of the inner wall of the support housing 31, said potion of the inner wall being at a second bottom (second end) of the support housing 31. The first holding unit 36 continuously generates and applies the external force (pushing force) 61 to the sliding unit 32 in a direction that pushes the sliding unit 32 back toward the pressure inlet 31c. Preferably, the first holding unit 36 may hold the center of the second bottom surface of the sliding unit 32 directly (or via the conductive plate 37). As a result, dispersion of the external force 61 generated by the first holding unit 36 may be suppressed. An inner diameter of a coil of the first holding unit 36 may be larger than the diameter of the second open end of the second through-hole 32b (for example, about same as the diameter of the sliding unit 32), so that the second open end of the second through-hole 32b exposed at the second bottom surface of the sliding unit 32 and the atmospheric opening 31d of the support housing 31 are exposed inside the coil cylinder of the first holding unit 36.

The compressive load 62 from the pressure medium 52 is applied to the first holding unit 36 via the sliding unit 32 when the switch 13 is on, whereby the first holding unit 36 shortens. On the other hand, when the switch 13 is off, the pressure medium 52 disappears, whereby the first holding unit 36 pushes the sliding unit 32 back toward the pressure inlet 31c due to a repulsive force (elastic force) that tries to return the first holding unit 3 to its natural length. Further, when the switch 13 is in the completely off state, the first holding unit 36 maintains its natural length (or a state in which the coil length is at its maximum) and keeps the sliding unit 32 as close as possible to the pressure inlet 31c within the support housing 31. The first holding unit 36 is nearly always exposed to the atmosphere and is only momentarily exposed to the exhaust gas 50 that flows out from the second through-hole 32b. Thus, the first holding unit 36 is formed by a general material such as steel special use stainless (SUS) configuring a compression coil spring. Preferably, the first holding unit 36 is formed of a material not attracted to a later-described electromagnet 38.

The second holding unit 39 has the function of keeping the sliding unit 32 on the atmospheric opening 31d side of the support housing 31 so that the elastic energy of the first holding unit 36 does not cause the sliding unit 32 to return to the pressure inlet 31c side of the support housing 31 when the switch 13 is in the completely on state. In particular, the second holding unit 39 has a function of generating an attractive force 63 for pulling and holding the sliding unit 32, which has been pushed toward the atmospheric opening 31d by the pressure medium 52, toward the atmospheric opening 31d inside the support housing 31. In other words, the first holding unit 36 is maintained in a compressed state by a resultant force of the pressure medium 52 pushing the sliding unit 32 toward the atmospheric opening 31d (the compressive load 62 on the first holding unit 36) and the attractive force 63 from the second holding unit 39. As a result, the first holding unit 36 is kept in a shortened state. Thus, the sliding unit 32 is kept on the atmospheric opening 31d side of the support housing 31, and the switch 13 is maintained in the completely on state at all times while the engine is running.

More specifically, for example, the second holding unit 39 includes the conductive plate 37 and the general electromagnet 38. The conductive plate 37 and the electromagnet 38 are disposed apart from the first holding unit 36; and the conductive plate 37 and the electromagnet 38 face each other in the axial direction of the sliding unit 32. The conductive plate 37 is disposed at (for example, adhered to) the second bottom surface of the sliding unit 32. The conductive plate 37 suffices to have a shape in a plan view, that does not block the second open end of the second through-hole 32b of the sliding unit 32 and may be suitably set according to the position of the second open end of the second through-hole 32b. For example, the conductive plate 37 may be a circular metal plate with a diameter substantially a same as the diameter of the sliding unit 32 and having an opening so as to expose the second through-hole 32b of the sliding unit 32 or may be a substantially rectangular shaped metal plate covering at least a portion of the second bottom surface of the sliding unit 32 facing the atmospheric opening 31d.

The electromagnet 38 is formed by winding a coil (not depicted) a predetermined number of times around a cylindrical core containing a magnetic material, a first end of the core being fixed (for example, adhered) to a portion of the inner wall of the support housing 31, said portion being at the second bottom of the support housing 31 facing the atmospheric opening 31d, and the first end of the core being fixed at a position that does not block the atmospheric opening 31d. A second end of the electromagnet 38 (coil) faces the conductive plate 37 in the axial direction of the sliding unit 32. The coil of the electromagnet 38 continues to be powered by the power source IC of the ECU directly or indirectly when the engine is running. As a result, when the engine is running, the electromagnet 38 is powered by the power source IC of the ECU and thus, continuously generates a magnetic force 64. For example, wiring for supplying power from the power source IC of the ECU to the pressure sensor chip 3 may be branched and connected to the coil of the electromagnet 38. The magnetic force 64 of the electromagnet 38 generates an attractive force that pulls the conductive plate 37 toward the electromagnet 38. When the engine is stopped, the supply of power from the power source IC of the ECU to the coil of the electromagnet 38 stops and thus, the magnetic force 64 of the electromagnet 38 disappears.

The attractive force that pulls the conductive plate 37 toward the electromagnet 38 (i.e., toward the atmospheric opening 31d) constitutes the attractive force 63 for keeping the sliding unit 32 positioned toward the atmospheric opening 31d. Therefore, the magnetic force 64 of the electromagnet 38 is strong enough to generate the attractive force 63 capable of keeping the sliding unit 32 at a predetermined position (the position where the switch 13 is in the completely on state) so that the sliding unit 32, which has been pushed toward the atmospheric opening 31d by the pressure medium 52, is not pushed back toward the pressure inlet 31c by the external force 61 from the first holding unit 36. The pressure medium 52 pushes the sliding unit 32 toward the atmospheric opening 31d and the switch 13 is in the completely on state (or approaches the completely on state) and thus, when the conductive plate 37 and the electromagnet 38 approach each other and are within a predetermined distance, the conductive plate 37 and the electromagnet 38 are attracted to each other, whereby the position of the sliding unit 32 is fixed.

In the switch 13 described above, configuration may be such that the second through-hole 32b is omitted and only the first through-hole 32a is provided in the sliding unit 32. In this instance, the sliding unit 32 is free of the second through-hole 32b and thus, when the switch 13 is in the completely off state, the pressure detection chamber 2 and the first pipe 21 are sealed by the sliding unit 32 and no gas flows into the pressure detection chamber 2. As a result, when the switch 13 is in the completely off state (the engine is stopped), the pressure sensor chip 3 may be shielded from the exhaust gas 50. Further, the pressure detection chamber 2 is not exposed to the outside air even after the engine has stopped and thus, is shielded from various external pressure media. When the switch 13 is on, as described above, the first through-hole 32a of the sliding unit 32 is connected between the first and second pipes 21, 22 and thus, the pressure detection chamber 2 and the exhaust pipe 40 are spatially continuous.

The exhaust pipe 40 is a hollow, cylindrical resin pipe through which the exhaust gas (combustion gas) 50 flows during the exhaust stroke of the engine and connects the cylinders of the engine (not depicted) and the outside. The exhaust gas 50 continuously flows from the exhaust pipe 40 into the second pipe 22 when the engine is running, and when the switch 13 is on, the exhaust gas 50 passes through the second pipe 22, the first through-hole 32a of the sliding unit 32 of the switch 13, and the first pipe 21 and is sent to the pressure detection chamber 2, as the pressure medium 51. Further, the exhaust gas 50 continuously flows from the second pipe 22 to the third pipe 23 when the engine is running and is sent to the support housing 31 from the pressure inlet 31c as the pressure medium 52. An O-ring (not depicted) is provided around an outer periphery of the second pipe 22 to seal a gap between the exhaust pipe 40 and the second pipe 22. The O-ring maintains the airtightness between the exhaust pipe 40 and the second pipe 22.

Operation of the semiconductor package 10 according to the embodiment is described. As depicted in FIG. 1, when the engine is stopped, no air (oxygen) is taken into the engine and thus, the sliding unit 32 of the switch 13 of the semiconductor package 10 maintains the completely off state only by receiving the physical external force 61 from the first holding unit 36 (the elastic force that causes the first holding unit 36 to return to its natural length). The sliding unit 32 is kept as close as possible to the pressure inlet 31c within the support housing 31 by the first holding unit 36. As a result, the first and second pipes 21, 22 of the pressure intake part 12 are maintained spatially isolated from each other, and the inside of the pressure detection chamber 2 of the pressure sensor 11 and the inside of the first pipe 21 are shielded from the exhaust gas 50 at all times, when the engine is stopped. In addition, the first pipe 21 and the atmospheric opening 31d of the support housing 31 of the switch 13 are coupled via the second through-hole 32b of the sliding unit 32, and the inside of the pressure detection chamber 2 is open to the atmosphere via the atmospheric opening 31d.

The outside air (atmosphere) flows into the pressure detection chamber 2 from the atmospheric opening 31d and gas inside the pressure detection chamber 2 is replaced with the outside air and thus, as described hereinafter, when the engine is running, the exhaust gas 50 that has flowed into the pressure detection chamber 2 may be evacuated outside when the engine is stopped. Bidirectional gas flow through the first pipe 21 and the second through-hole 32b is indicated by a double-headed arrow 71. The inside of the second through-hole 32b of the sliding unit 32 and a portion of the inside of the support housing 31 closer to the atmospheric opening 31d than is the sliding unit 32 are exposed to the atmosphere at all times regardless of the operating state of the automotive vehicle (when the engine is stopped or when the engine is running). The inside of the exhaust pipe 40 and the inside of each of the second and third pipes 22, 23 of the pressure intake part 12 are kept airtight at all times regardless of the operating state of the automotive vehicle and are exposed to the exhaust gas 50 in the exhaust pipe 40. When the engine is stopped, the inside of the first through-hole 32a of the sliding unit 32 may be exposed to the exhaust gas 50 that remains in the exhaust pipe 40 or may be open to the atmosphere via the first pipe 21.

On the other hand, as depicted in FIG. 6, when the engine is running, air is taken into the engine and in the combustion/expansion process of the engine, gas generated from combustion inside the cylinders of the engine during the exhaust stroke flows into the exhaust pipe 40 as the exhaust gas 50. The direction of the arrow of the exhaust gas 50 indicates the direction of flow of the exhaust gas 50. A portion of the exhaust gas 50 flows, as the pressure medium 51, into the second pipe 22 of the pressure intake part 12, from the exhaust pipe 40. A branched portion of the exhaust gas 50 flowing into the second pipe 22 flows into the third pipe 23 of the pressure intake part 12 and is sent inside the support housing 31 of the switch 13, from the pressure inlet 31c as the pressure medium 52. The inside of the third pipe 23 and a portion of the inside of the support housing 31 of the sliding unit 32, said portion being closer to the pressure inlet 31c than is the sliding unit 32, are kept airtight by the sealing member 33. Pressure from the pressure medium 52 is applied to the pressure-sensitive surface (the first bottom surface of the sliding unit 32, facing the pressure inlet 31c) of the sliding unit 32, whereby the switch 13 turns on.

When the switch 13 is on, pressure from the pressure medium 52 is applied to the sliding unit 32 and the sliding unit 32 moves (slides) inside the support housing 31 in a direction to the atmospheric opening 31d. As a result, coupling of the first pipe 21 and the first through-hole 32a of the sliding unit 32 begins. Bidirectional gas flow in the first pipe 21 and the first through-hole 32a is indicated by a double-headed arrow 72. At this time, the first pipe 21 and the second through-hole 32b of the sliding unit 32 may be in a state of being coupled together or the first through-hole 32a of the sliding unit 32 may be spatially continuous with the atmospheric opening 31d. The second pipe 22 is still isolated from the first through-hole 32a of the sliding unit 32. As depicted in FIG. 7, when the sliding unit 32 is further pushed toward the atmospheric opening 31d by the pressure medium 52, the first pipe 21 and the second through-hole 32b of the sliding unit 32 are spatially isolated from each other. The pressure detection chamber 2, the first pipe 21, and the first through-hole 32a are sealed by the sealing members 33, 34 and shielded from the atmosphere by the sealing member 34.

Further, as depicted in FIG. 8, when the sliding unit 32 is further pushed toward the atmospheric opening 31d by the pressure medium 52, the second pipe 22 begins to be coupled with the first through-hole 32a of the sliding unit 32. As a result, the exhaust pipe 40 and the pressure detection chamber 2 are coupled to each other, and a portion of the exhaust gas 50 begins to be sent as the pressure medium 51 to the pressure detection chamber 2 via the second pipe 22 and the first through-hole 32a. Bidirectional gas flow in the second pipe 22 and the first through-hole 32a is indicated by a double-headed arrow 73. As depicted in FIG. 9, when the sliding unit 32 is pushed toward the atmospheric opening 31d until the first and second pipes 21, 22 are completely coupled to each other by the first through-hole 32a of the sliding unit 32, the switch 13 is in the completely on state. The gap between the second pipe 22 and the first through-hole 32a of the sliding unit 32 is sealed by the sealing member 35. Thereafter, the sliding unit 32 continues to keep the first and second pipes 21, 22 completely coupled to each other by the second holding unit 39 while the engine is running.

When the switch 13 is in the completely on state, the path (path from the exhaust pipe 40 to the pressure detection chamber 2) of the pressure medium 51 is spatially continuous at all times and the pressure sensor chip 3 is not shielded from the exhaust gas 50. Further, airtightness of the channel for the pressure medium 51 from the exhaust pipe 40 to the pressure detection chamber 2 is maintained by the O-ring that seals the gap between the exhaust pipe 40 and the second pipe 22 and by the sealing members 33 to 35 inside the support housing 31. Thus, the pressure medium 51 that flows into the pressure intake part 12 from the exhaust pipe 40 flows inside the pressure intake part 12 and is sent to the pressure sensor chip 3 without leakage. The resistance value of the strain gauge changes according to the pressure applied to the diaphragm 3a of the pressure sensor chip 3 by the pressure medium 51 and the pressure sensor 11 outputs the amount of change in the resistance value of the strain gauge, as an electrical signal, to an external circuit. The pressure medium 52 and the second holding unit 39 apply a compressive load (resultant force of the compressive load 62 and the attractive force 63) to the first holding unit 36 via the sliding unit 32 and the first holding unit 36 is maintained in a maximally compressed state when the switch 13 is in the completely on state.

The intake of air into the engine stops when the automotive vehicle stops and thus, the exhaust gas 50 remains inside the exhaust pipe 40. The flow of the exhaust gas 50 stops, whereby the pressure medium 52 disappears, the external force that pushes the sliding unit 32 toward the atmospheric opening 31d disappears, and the switch 13 turns off. Power supply to the second holding unit 39 also stops and thus, the magnetic force 64 of the electromagnet 38 of the second holding unit 39 disappears and the attractive force 63 that pulls the sliding unit 32 toward the atmospheric opening 31d also disappears. The compressive load 62 applied to the first holding unit 36 by the pressure medium 52 disappears and thus, the first holding unit 36 attempts to return to its natural length and thereby pushes the sliding unit 32 back toward the pressure inlet 31c and keeps the sliding unit 32 as close as possible to the pressure inlet 31c within the support housing 31. As a result, the completely off state of the switch 13 is maintained. Thus, as described above, the pressure detection chamber 2 is shielded from the exhaust gas 50 and is open to the atmosphere, and the air inside the pressure detection chamber 2 is replaced with the outside air.

As described above, according to the embodiment, the pressure intake part is a pipe for sending exhaust gas, which flows in from the exhaust pipe, to the pressure detection chamber as a pressure medium and the pressure intake part has the switch, which receives a physical, external force and moves to open and close (turn on and off). The switch, when in the on state, spatially couples the exhaust pipe and the pressure detection chamber via the pressure intake part and, when in the off state, spatially isolates the exhaust pipe and the pressure detection chamber from each other. When the switch is in the off state, the inside of the pressure detection chamber may be shielded from the high-temperature, high humidity exhaust gas inside the exhaust pipe and thus, deterioration of the pressure sensor chip and the components thereof due to rust, corrosion, moisture absorption expansion, etc. may be suppressed. Further, according to the embodiment, the switch has the atmospheric opening for taking in the outside air into the pressure detection chamber during the off state. During the off state of the switch, the inside of the pressure detection chamber is open to the atmosphere and may be exposed to the atmosphere, whereby degradation of the pressure sensor chip and the components thereof may be significantly decreased.

Further, according to the embodiment, the turning on and off of the switch may be physically implemented easily by the starting and stopping of the engine (i.e., the presence and absence of the pressure medium), the simple sliding mechanism of the switch, the elastic force of the spring, and the magnetic force of the electromagnet. Further, the completely on state of switch is maintained by the magnetic force of the electromagnet and thus, even when the inflow of the pressure medium into the pressure intake part stops when the engine is running, the exhaust pipe and the pressure detection chamber may be kept spatially coupled.

In the foregoing, the present disclosure is not limited to the embodiments described above and various modifications within a range not departing from the spirit of the present disclosure are possible. For example, a semiconductor package having a pressure sensor and a pressure intake part (corresponds to the first pipe) similar to the reference example may be supplemented with the switch of the pressure intake part and the second and third pipes of the present disclosure.

The semiconductor package according to the present disclosure achieves an effect in that degradation may be suppressed.

As described, the semiconductor package according to the present disclosure is useful for on-board automotive semiconductor packages that are for pressure measurement and installed to a pipe (exhaust pipe) of an internal combustion engine (engine) and is particularly suitable in instances when a package is to be installed to a pipe (exhaust pipe) of an exhaust system to measure exhaust pressure.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A semiconductor package for detecting a pressure of a gas flowing in engine piping, the semiconductor package comprising:
a pressure sensor chip configured to convert a pressure of a first pressure medium into an electrical signal, the pressure of the first pressure medium being the pressure of the gas to be detected;
a pressure detection chamber housing the pressure sensor chip such that the pressure sensor chip detects the pressure of the first pressure medium sent thereto; and
a pressure intake part disposed between the engine piping and the pressure detection chamber, the gas flowing into the pressure intake part from the engine piping as the first pressure medium, wherein
the pressure intake part has a switch configured to switch between an open state and a closed state by physically receiving an external force, and
the switch:
in the open state, spatially couples the engine piping and the pressure detection chamber via the pressure intake part, and
in the closed state, spatially isolates the engine piping and the pressure detection chamber from each other.

2. The semiconductor package according to claim 1, wherein the switch, by receiving a pressure of a second pressure medium as the external force, moves in a first direction to enter the open state, the second pressure medium being a medium branching from the first pressure medium.

3. The semiconductor package according to claim 2, wherein
the switch has a first holding unit for suppressing movement of the switch in the first direction, and
the switch is pushed back by the first holding unit in a second direction, which is opposite to the first direction, to enter the closed state in response to disappearance of the pressure of the second pressure medium.

4. The semiconductor package according to claim 3, wherein
the first holding unit is a compression coil spring that generates a pushing force that pushes the switch back in the second direction, and
the switch continuously receives the pushing force from the first holding unit.

5. The semiconductor package according to claim 4, wherein the switch is kept in the closed state by the pushing force from the first holding unit.

6. The semiconductor package according to claim 2, wherein
the switch has a second holding unit that pulls the switch in the first direction, and holds the switch in response to the switch being in the open state or the switch approaching the open state.

7. The semiconductor package according to claim 6, wherein the second holding unit has an electromagnet that generates an attractive force that pulls the switch in the first direction.

8. The semiconductor package according to claim 7, wherein the second holding unit pulls and holds the switch by the attractive force generated by the electromagnet in response to the switch having moved in the first direction and reached a position from the electromagnet that is less than a predetermined distance.

9. The semiconductor package according to claim 7, wherein a power for a coil of the electromagnet and a power for the pressure sensor chip are supplied by a common power source.

10. The semiconductor package according to claim 1, wherein the switch has an atmospheric opening, through which the pressure detection chamber and outside the semiconductor package are spatially coupled during the closed state of the switch.
